(19) United States
(12) Patent Application Publication
(10) Pub. No.: US 2021/0296810 A1
(43) Pub. Date: Sep. 23, 2021

(54) FIXING DEVICE TO SECURE AN RJ-INTERFACE

(71) Applicant: Janne MÄIHÄNIEMI, Kyröskoski (FI)

(72) Inventor: Janne MÄIHÄNIEMI, Kyröskoski (FI)

(21) Appl. No.: 17/259,022

(22) PCT Filed: Jan. 18, 2019
(86) PCT No.: PCT/FI2019/050039

§ 371 Date: Jan. 8, 2021

(30) Foreign Application Priority Data
Jul. 12, 2018 (FI) 20185638

(51) Int. Cl. H01R 13/426; H01R 13/436; H01R 13/58

(52) U.S. Cl. CPC H01R 13/426; H01R 24/64; H01R 13/5808; H01R 13/4364

(57) ABSTRACT

A fixing device to secure an RJ interface is intended for securing the interconnection between an RJ port of an electric actuator and a cable provided with an RJ connector in order to eliminate problems resulting from disturbances in electrical contact between the RJ port and the RJ connector. The fixing device includes a frame member capable of being immovably fixed to the actuator (1) with first fastening elements- and a support member for having the RJ connector-equipped cable fixed immovably thereto with second fastening elements.

### FIELD

The disclosed embodiments relate to a fixing device according to the preamble of an independent claim directed thereto for securing an RJ interface.

### BACKGROUND

RJ (Registered Jack) connectors are commonly used in telephone, data terminal and data transfer services, and particularly in industry, e.g. in various process control services or the like, noteworthy examples of the available RJ connector types being:

RJ10 (4/4)=4-pin,
RJ11 (6/4)=4-pin (wide, like RJ12),
RJ12 (6/6)=6-pin,

### RJ45=8-pin (UTP, STP), and

### RJ48=10-pin 10/10 (UTP).

In the foregoing, the code UTP (Unshielded Twisted Pair) stands for unprotected and STP (Shielded Twisted Pair) for protected.

RJ-interface is used e.g. in desktop computers, WiFi routers, switches, firewalls, and in numerous other computer network components, generally speaking in interconnection between an electric actuator's RJ port and an RJ connector-equipped cable. In this case, practical problems are mainly caused by “slackness” of the RJ coupling as a mechanical connection between the RJ port and the RJ connector allow a small movement of an RJ connector-equipped cable, resulting dis-orders in electrical contact between the RJ port and the RJ connector. Thus, e.g. a detachment of the network cable is possible, which in practice may result in difficult-to-detect malfunctions.

In industry, Ethernet-based fieldbuses include e.g. Ethernet/IP, Profinet, Ethercat, etc. One noteworthy practical example of the RJ interface problem in industry, regarding e.g. inverter operations for engines or actuators, is interconnection between one or more RJ communication cards and an RJ cable connectable thereto, the former being releasably connectable to the control unit of a programmable logic controller/PLC and/or an inverter, said interconnection being exposed to both vibration and contaminants emanating from the environment. Here, electrical contact disturbances result in undefined malfunctions, entailing at worst a restart of the process equipment should the electrical contact be cut off.

In the foregoing context, the elimination of vibration-induced problems, among others, has been attempted by using between a programmable logic controller and one or more RJ communication cards releasably connectable thereto a rubber seal, nevertheless without achieving a decisive improvement as it is not possible to thereby secure the interconnection between a communication card and an RJ cable connectable thereto. U.S. Pat. No. 5,336,107 discloses a device for connecting electrical cords for electrical tools and appliances, and more particularly, relates to apparatus and methods for maintaining secure connection of a first electrical cord and plug to another cord and plug. The fastener elements may be mushroomtype fastener elements such as a Dual Lock. U.S. Pat. No. 2,728,058 discloses a holder for preventing separation of an electrical plug from a receptacle part.

### SUMMARY

According to the aspects of the disclosed embodiments are directed to a fixing device , intended for securing an RJ interface, to provide decisive improvement regarding the foregoing problems and to thereby raise substantially the available state of the art. The fixing device according to the disclosed embodiments is principally characterized by what is presented in the characterizing clause of an independent claim directed thereto.

As the most important benefits of a fixing device according to the disclosed embodiments should be mentioned the simplicity and effectiveness of its construction and employment, it being by virtue of a fixing device, which is extremely simple in construction, easily manufactured from a material most appropriate for each given application, and quickly installable to its service position, that it will be possible to eliminate some of the disorders and service disruptions caused by electrical contact problems occurring in data transmission.

The fixing device of the disclosed embodiments enables prevention of e.g. vibration-induced disorders, especially in connection with so-called rolling stock and/or in applications exposed to vibration. In addition, the disclosed embodiments inhibits vandalism and prevents inadvertent detachments of RJ cables. In attaching the fixing device to each given electric actuator and to one or more RJ cables connectable thereto, it is possible to utilize a mutual crimp joint and/or screw locking thereof by making use of e.g. cooling vents included in the actuator or by simply using e.g. a cable tie when connecting the cable. Further, by virtue of adjustment elements utilized in the disclosed embodiments, the fixing device lends itself to being used in connection with a most diversified range of electric actuators differing from each other especially in terms of the width thereof.

Other preferred embodiments for a fixing device of the present disclosure are presented in dependent claims directed thereto.

### BRIEF DESCRIPTION OF THE DRAWINGS

The disclosed embodiments will be described in detail in the subsequent specification with reference to the accompanying drawings, in which

FIG. 1 shows by way of example, in a perspective view, a fixing device of the disclosed embodiments being utilized in connection with an electric actuator connected to one RJ cable,

FIG. 2 shows by way of example, in a perspective view, a fixing device of the disclosed embodiments being utilized in connection with a so-called single row RJ junction box,

FIG. 3 shows by way of example, in a perspective view, a fixing device of the disclosed embodiments being utilized in connection with a so-called dual row RJ junction box, and

FIG. 4 shows further by way of example, in a perspective view, one preferred fixing device of the disclosed embodiments for securing the connection between an RJ communication card releasably connectable to a programmable logic controller (PLC) and an RJ cable connectable thereto.

### DETAILED DESCRIPTION

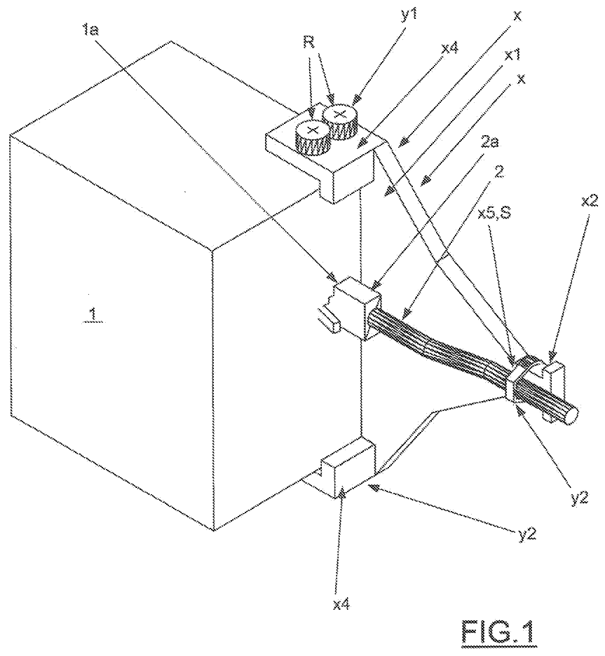

The disclosed embodiments relates to a fixing device to secure an RJ interface, which is intended for securing the interconnection between an RJ port la of an electric actuator 1 and a cable 2 provided with an RJ connector 2a in order to eliminate problems resulting from disturbances in electrical contact between the RJ port and the RJ connector. The fixing device x includes, in reference e.g. to an embodiment shown by way of example in FIG. 1, a frame member x1, wherein a first part of the frame member (x1) is configured to be immovably fixed to a first side of the actuator 1 with first fastening elements y1 and a second part of the frame member (x1) is configured to be immovably fixed to a second side of the actuator (1) with first fastening elements (y1), wherein the second side of the actuator (1) is the opposite side of the actuator (1) than the first side, so that a mutual crimp joint is formed around the actuator (1) when the actuator (1) is arranged between the first and second parts of the frame member (x1) of the fixing device (x) or the first and the second fastening elements (y1, y2) are immovably fixed in a ventilation opening or grate of the actuator (2) in the first and second sides of the actuator (1), and a support member x2 between the first and second parts of the frame member (x1) for having the RJ connector-equipped cable 2; 2a fixed immovably thereto with second fastening elements y2, wherein the frame member (x1) and the support member (x2) are made from rigid material.

In a preferred embodiment for a fixing device of the present disclosure, its frame member x1 and support member x2 are constructed as an integral entity, wherein the rigid material is a structurally rigid metal, plastic, reinforced plastic, ceramic, composite material and/or the like.

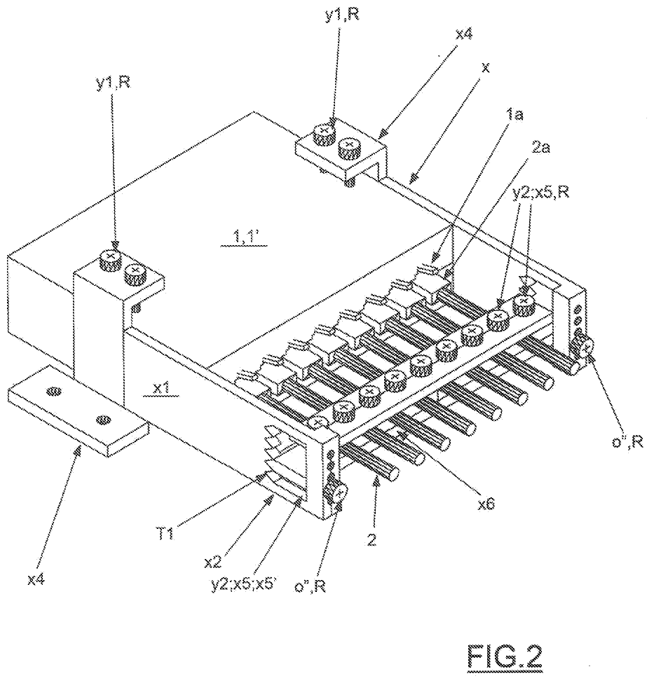

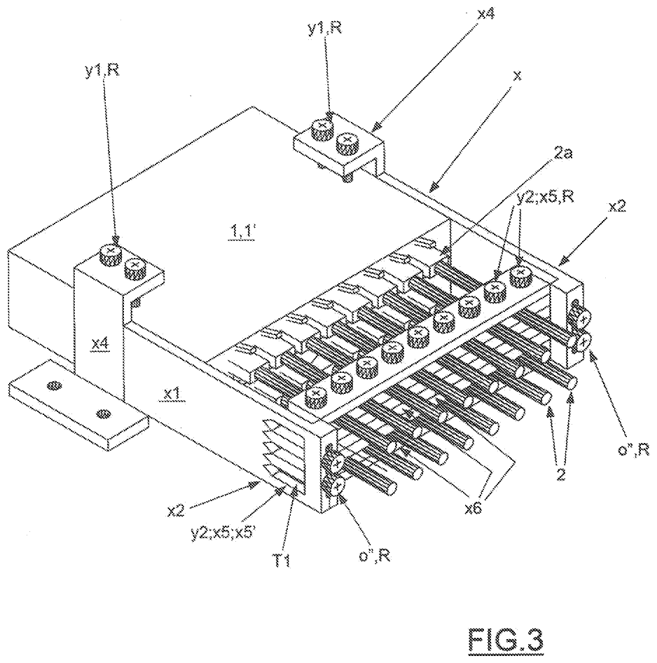

In a further preferred embodiment for a fixing device of the present disclosure, referring specifically to FIG. 1, its frame member x1 is provided with a fastening arrangement x4 for the first fastening elements y1 for coupling the fixing device in a screw-locked manner R to the actuator 1 and/or, as depicted in FIGS. 2 and 3, to a base supporting the actuator.

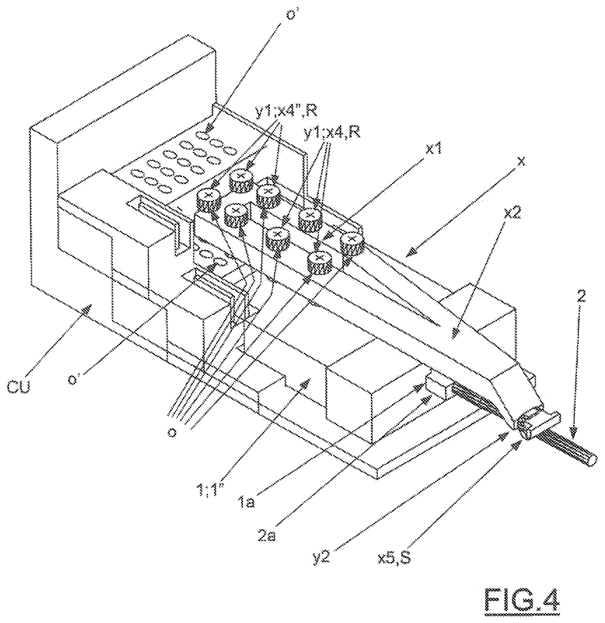

In another preferred embodiment for a fixing device of the disclosed embodiments, its support member x2 is provided with a fastening arrangement x5 for the second fastening elements y2 for coupling the fixing device x, e.g. in a screw-locked R manner according to a principle depicted in FIGS. 2 and 3 or e.g. in a cable-tied S manner according to a principle depicted in FIGS. 1 and 4, to the RJ cable 2.

In reference to the FIGS. 2 and 3, a fixing device may comprise adjustment elements T1 for adjusting a mutual distance between the first fastening elements y1 by means of one or more intermediate members x6, which interconnect the support members x2 present on opposite sides of the fixing device, are capable of being screw-locked R with threaded holes o″ included in the ends of the frame members to each desired length thereof, and are capable of having cut off those parts thereof which protrude from sliding holes included in the support members.

It is particularly shown in FIGS. 2 and 3 that use is made of a fixing device which is further provided with a row connector arrangement x5′ for the second fastening elements y2 for securing the coupling especially between an RJ junction box 1; 1′ and the RJ cables 2 connectable thereto in one layer as shown in FIG. 2 and in two superimposed layers and in parallel as shown in FIG. 3 in a screw-locked manner R against the intermediate members x6, which interconnect the fixing device's support members x2 and are capable of being locked, as described earlier, in a fixed position in a screw-locked manner R by means of the threaded holes o″ included in the ends of the frame members.

Referring especially to FIG. 4, the fixing device is provided with a fastening arrangement x5 for the second fastening elements y2 for securing the interconnection between one or more RJ communication cards 1; 1″ releasably connectable especially to a programmable logic and/or inverter control unit CU and the RJ cable 2 connectable thereto. In the embodiment shown in FIG. 4, the fixing device's fastening arrangement x4 for the first fastening elements y1 further comprises elements x4″ especially for fixing the RJ communication card 1; 1″ in a screw-locked manner R also to the control unit CU, which is most favorably carried out with screws attaching to cooling apertures 0′ of the control unit CU through a hole array o included in the fixing device x. The control unit CU of FIG. 4 includes interfaces for three communication cards 1″, the centermost location of which being reserved for the fixing device.

It is obvious that the present disclosure is not limited to the embodiments described or explained above, but it can be varied within the basic concept of the disclosed embodiments as required by applications in each particular case. First, in addition to or instead of the above-described screw or cable tie attachments, it is naturally possible to make use of e.g. adhesive, double-sided tape, Velcro attachment or e.g. spring-loaded quick release locking provided in the ventilation opening or grate of an actuator, etc. The fixing device according to the disclosed embodiments is also capable of being manufactured in smaller or larger subentities from a most diverse range of materials, by using a most diverse range of manufacturing methods. The present disclosure is also capable of being exploited in RJ interfaces used in a most diverse range of data transmission demands.

1-9. (canceled)

10. A fixing device to secure an RJ interface, which is intended for securing the interconnection between an RJ port of an electric actuator and a cable provided with an RJ connector in order to eliminate problems resulting from disturbances in electrical contact between the RJ port and the RJ connector, wherein the fixing device includes a frame member, wherein a first part of the frame member is configured to be immovably fixed to a first side of the actuator with first fastening elements and a second part of the frame member is configured to be immovably fixed to a second side of the actuator with first fastening elements, wherein the second side of the actuator is the opposite side of the actuator than the first side, so that a mutual crimp joint is formed around the actuator when the actuator is arranged between the first and second parts of the frame member of the fixing device or the first and the second fastening elements are immovably fixed in a ventilation opening or grate of the actuator in the first and second sides of the actuator, and a support member between the first and second parts of the frame member for having the RJ connector-equipped cable fixed immovably thereto with second fastening elements, wherein the frame member and the support member are made from rigid material.

11. The fixing device according to claim 10, wherein its frame member and support member are constructed as an integral entity and the rigid material is a structurally rigid metal, plastic, reinforced plastic, ceramic, composite material and/or the like.

12. The fixing device according to claim 10, wherein its frame member is provided with a fastening arrangement for the first fastening elements for coupling the fixing device in a screw-locked manner to the actuator and/or to a base supporting the actuator.

13. The fixing device according to claim 10, wherein its support member is provided with a fastening arrangement for the second fastening elements for coupling the fixing device in a screw-locked, cable-tied manner to the RJ cable.

14. The fixing device according to claim 13, wherein the second fastening elements are arranged in a cable tie type manner.

15. The fixing device according to claim 10, wherein the second fastening element comprises a fastening arrangement for securing the interconnection between one or more RJ communication cards releasably connectable to a programmable logic and/or inverter control unit and the RJ cable connectable thereto.

16. The fixing device according to claim 10, wherein the first fastening elements comprises a fastening arrangement comprising elements for fixing the RJ communication card in a screw-locked manner to the control unit of a programmable logic.
